(19) United States
(12) Patent Application Publication
(10) Pub. No.: US 2013/0088502 A1
(43) Pub. Date: Apr. 11, 2013

(54) DISPLAY DRIVING DEVICE

(71) Applicants: Cheng-Chung Shih, New Taipei City (TW); Wing-Kai Tang, Hsinchu City (TW); Jin-Sheng Hsieh, Hsinchu County (TW); Chia-Hsin Tung, Hsinchu City (TW)

(72) Inventors: Cheng-Chung Shih, New Taipei City (TW); Wing-Kai Tang, Hsinchu City (TW); Jin-Sheng Hsieh, Hsinchu County (TW); Chia-Hsin Tung, Hsinchu City (TW)

(73) Assignee: NOVATEK MICROELECTRONICS CORP., Hsinchu (TW)

(21) Appl. No.: 13/454,087

(22) Filed: Apr. 24, 2012

(30) Foreign Application Priority Data
Oct. 7, 2011 (TW) 100136541

(51) Int. Cl. G09G 5/36

(52) U.S. Cl. 345/545

(57) ABSTRACT

A display driving device is disclosed. The display driving device includes an image data transmission interface, a frame buffer, and an over-driving processor. The image data transmission interface transmits image data, which is then received by and stored in the frame buffer. The over-driving processor is coupled to the image data transmission interface to receive current image data provided by the image data transmission interface, and also coupled to the frame buffer to receive previous image data saved in the frame buffer. In a dynamic display mode, the over-driving processor generates a display driving signal according to the previous image data and the current image data.

### CROSS-REFERENCE TO RELATED APPLICATION

This application claims the priority benefit of Taiwan application serial no. 100136541, filed on Oct. 7, 2011. The entirety of the above-mentioned patent application is hereby incorporated by reference herein and made a part of this specification.

### BACKGROUND OF THE INVENTION

1. Field of the Invention

The invention relates to a display device, and more particularly relates to a display driving device which has the over driving ability and a display apparatus includes the display driving device.

2. Description of Related Art

In the prior art of display driving devices, a so-called “over driving” technique is often applied to improve the display effect of motion images. The over driving technique is when displaying an image, if a grayscale value of a pixel has a larger change in a continuous time period, the driving voltage is increased (or decreased) excessively so a corresponding LCD cell could be rotated faster and the grayscale value needed for desired brightness and color of the pixel can be reached for shorter time period.

To implement the over driving technique, the prior art disposes two frame buffers in the display driving device. The first frame buffer is configured to provide new (current) image data, while the second frame buffer is configured to store the image data from the first frame buffer and provide the old (previous) image data. The display driving device of the prior art has a processor for calculating the change of the grayscale value for each pixel based on the current image data and the previous image data provided by the two frame buffers in order to recognize the over driving voltage value needed for each pixel. In general, a single frame buffer has to be capable to store a complete frame data. In other words, the larger the display driving device, the larger the frame buffer size needed. In addition, to allow the implementation of the over driving technique, the display driving device of the prior art requires very large circuit size and area for the two frame buffers, further increasing the device cost.

### SUMMARY OF THE INVENTION

A display driving device is provided, which can effectively minimize the circuit size and area needed in order to reduce the device production cost. Moreover, a display apparatus including the display driving device is further disclosed.

In one aspect, a display driving device is provided, comprising an image data transmission interface, a frame buffer, and an over-driving processor. The image data transmission interface is configured to transmit image data. The frame buffer is coupled to the image data transmission interface for storing the image data. The over-driving processor is coupled to the image data transmission interface for receiving the current image data provided by the image data transmission interface, and also coupled to the frame buffer for receiving the previous image data saved in the frame buffer. The over-driving processor in a dynamic display mode generates a display driving signal according to the previous image data and the current image data.

In an embodiment, the display driving signal is provided to a plurality of source driver circuits.

In an embodiment, the over-driving processor includes a lookup table and an arithmetic unit. The lookup table, coupled to the image data transmission interface and the frame buffer, looks up for a signal adjusting information corresponding to the previous image data and the current image data. The arithmetic unit, coupled to the lookup table and the image data transmission interface, executes an arithmetic computation upon the current image data to generate the display driving signal corresponding to the signal adjustment information.

In an embodiment, the arithmetic unit includes an adder to add the signal adjusting information to the current image data for generating the display driving signal.

In an embodiment, the display driving device further comprises a mode selection circuit. The mode selection circuit selects either transmitting the image data from the image data transmission interface to the over-driving processor or not, and selects either transmitting the image data from the frame buffer to the over-driving processor or transmitting the image data from the frame buffer to be the display driving signal according to whether the display driving device is in the dynamic display mode or not.

In an embodiment, the mode selection circuit which is in the static display mode that is non-dynamic does not transmit the image data from the image data transmission interface to the over-driving processor, but does transmit the image data from the frame buffer to be the display driving signal.

In an embodiment, the mode selection circuit further comprises a first output switch and a second output switch. The first output switch disposed between the arithmetic unit and a display driving signal output. The first output switch is conducted when it is in the dynamic display mode, and cut off when it is in the static display mode. The second output switch disposed between the frame buffer and the display driving signal output. The second output switch is cut off when it is in the dynamic display mode, and is conducted when it is in the static display mode.

In an embodiment, the mode selection circuit further includes a first input switch, a second input switch and a third input switch. The first input switch is disposed between the image data transmission interface and the lookup table. The second input switch is disposed between the image data transmission interface and the arithmetic unit. The third input switch is disposed between the frame buffer and the lookup table. The first, the second and the third input switch are conducted when those switches are in the dynamic display mode and cut off when those switches are in the static display mode.

In an embodiment, the display driving device further comprises a controller and a mode selection instruction register. The controller is coupled to the mode selection circuit to generate a mode selection instruction. The mode selection instruction register is coupled to the controller and provides a temporary storage for the mode selection instructions and sends out a mode selection signal according to the mode selection instruction to instruct whether the display driving device is in dynamic display mode or static display mode.

In another aspect, a display apparatus is provided, comprising a display panel and the display driving device which is above-mentioned and configured to generate a display driving signal to drive the display panel.

In summary, a display driving device is disclosed, which can directly receive the current image data provided by the image data transmission interface and the previous image data saved in the frame buffer when the display driving device is in the dynamic display mode. The current image data and the previous image data are processed to generate the display driving signal needed for the image display. Thereby, the current image data does not need to be stored in a buffer, allowing effective reduction of the memory size required in the display driving device. As a result, circuit size and area and hence the device production cost can be reduced.

In order to make the aforementioned and other features and advantages of the invention comprehensible, several exemplary embodiments accompanied with figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a schematic diagram of a display driving device in an embodiment of the present invention.

FIG. 2 illustrates a detailed structure of a over-driving processor in an embodiment of the present invention.

FIG. 3 schematically illustrates an arithmetic unit in an embodiment of the present invention.

FIG. 4 is a schematic diagram of a display driving device in an embodiment of the present invention.

FIG. 5 is a schematic diagram of a mode selection circuit of an embodiment in FIG. 4.

### DETAILED DESCRIPTION OF THE EMBODIMENTS

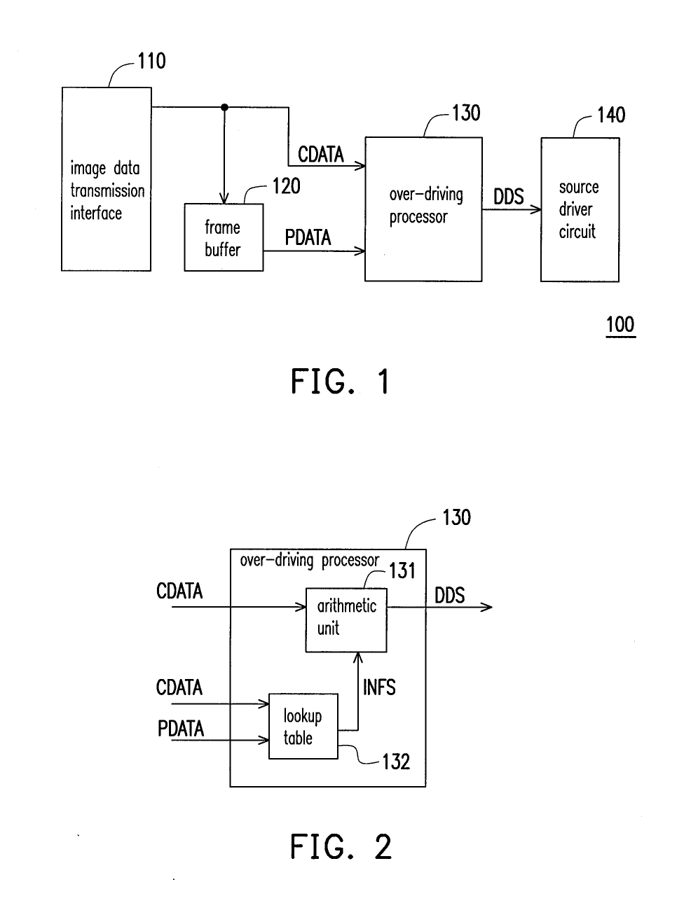

Referring to FIG. 1, FIG. 1 is a schematic diagram of a display driving device 100 in an embodiment of the present invention. The display driving device 100 disposed in, for example, a display apparatus, is adapted for driving a display panel (not shown in FIG. 1) to display the images. The display driving device 100 includes an image data transmission interface 110, a frame buffer 120 and an over-driving processor 130. The display driving device 100 may further comprise a source driver circuit 140. Note that the source driver circuit 140 could be integrated with the image data transmission interface 110, the frame buffer 120 and the over-driving processor 130 as an integrated circuit or disposed in another integrated circuit.

The image data transmission interface 110, for example, a RGB interface or a Host interface, is coupled to the frame buffer 120 and the over-driving processor 130 to transmit the image data. In the present embodiment, the current image data CDATA transmitted by the image data transmission interface 110 is sent to the frame buffer 120 and the over-driving processor 130 simultaneously. The frame buffer 120 temporarily stores the current image data CDATA and delivers the previous stored image data, i.e., the previous image data PDATA, to the over-driving processor 130. It should be noted that, the previous image data PDATA and the current image data CDATA are respectively the older data and the newer data of the image data. Further, because the current image data CDATA is directly outputted from the image data transmission interface 110 without being transmitted through any intermediate memory, buffer or data register, the current image data CDATA, generally speaking, is compatible to the specific data format of the image data transmission interface 110. In Contrast, the previous image data PDATA outputted from the frame buffer 120 is no longer conformed to the specific data format mentioned before.

When the display driving device 100 is in a dynamic display mode, the over-drive processor 130 generates a display driving signal DDS according to the previous image data PDATA from the frame buffer 120 and the current image data from the image data transmission interface 110.

The operation of the over-driving processor 130 is fully described in the following. When the display driving device 100 is in the dynamic display mode, the over-driving processor 130 compares the current image data CDATA to the previous image data PDATA, for example, calculating the difference between the grayscale values of the current image data CDATA and the previous image data PDATA for the same pixel to obtain a value applied for the display driving signal DDS for each pixel. Take pixel A as an example, when the grayscale value of pixel A in the current image data CDATA is a relatively high grayscale value 200, but the grayscale value of pixel A in the previous image data PDATA is a relatively low grayscale value 50, the over-driving processor 130 employed the difference of grayscale values (=150) to derive the value of the display driving signal DDS for pixel A.

Once the over-driving processor 130 generates the appropriate display driving signal DDS, the DDS is transmitted to the source driver circuit 140 and the source driver circuit 140 generates another driving signal (for example a driving current or a driving voltage) to drive the display panel according to the display driving signal DDS. In addition, the display diving signal DDS may be a digital signal and the source driver circuit 140 may have a built-in digital-to-analog converter (not shown in FIG. 1) to generate an analog driving signal correspondingly for driving the display panel.

Referring to FIG. 2, FIG. 2 illustrates a detailed structure of the over-driving processor 130 in an embodiment of the present invention, and the over-driving processor 130 could be employed by the display driving device 100 illustrated in FIG. 1. The over-driving processor 130 includes an arithmetic unit 131 and a lookup table 132. The arithmetic unit 131 is coupled to the image data transmission interface 110 and the lookup table 132 is coupled to the arithmetic unit 131, the image data transmission interface 110 and the frame buffer 120. The lookup table 132 receives the current image data CDATA and the previous image data PDATA from the image data transmission interface 110 and the frame buffer 120 respectively, and performs the looking-up operation according to the current image data CDATA and the previous image data PDATA in order to generate signal adjusting information INFS. In the present embodiment, the lookup table can be a two-dimensional lookup table that receives the current image data CDATA and the previous data PDATA as the two inputs. The two inputs, the current image data CDATA and the previous image data PDATA, are employed as the indexes for looking up the value used as the signal adjusting information INFS.

Using the above-mentioned pixel A as an example, if the grayscale value of the pixel A in the current image data CDATA is as same as that in the previous image data PDATA, the pixel A does not need to be driven by the over driving method. Therefore, the lookup table can generate the signal adjusting information equal to zero. On the other hand, if there is a large difference between the grayscale values of the pixel A in the current image data CDATA and the previous image data PDATA, the response of driving the pixel A should be speeded up, which means necessity of a higher level of over driving voltage. Therefore, the lookup table 132 correspondingly generates the signal adjusting information INFS representing a higher value. It should be noted that when the grayscale value of the pixel A in the current image data CDATA is greater than the grayscale value of the pixel A in the previous image data PDATA, the signal adjusting information INFS could be a positive value. In contrast, when the grayscale value of the pixel A in the current image data CDATA is lower than the grayscale value of the pixel A in the previous image data PDATA, the signal adjusting information INFS could be a negative value.

Moreover, the relationship among the signal adjusting information INFS, the current image data CDATA and the previous image data PDATA generated with the lookup table 132 could be obtained by designers performing tests on the display driving device 100. In a digitally-constructed lookup table 132, only a limited bit number may be provided to represent the relationship among the signal adjusting information INFS, the current image data CDATA and the previous image data PDATA. In such cases, an interpolation technique can be employed to obtain a higher resolution of the signal adjusting information INFS.

The arithmetic unit 131 is configured to receive the current image data CDATA as well as the signal adjusting information INFS, and the signal adjusting information INFS can be used for adjusting the current image data CDATA in order to generate the display driving signal.

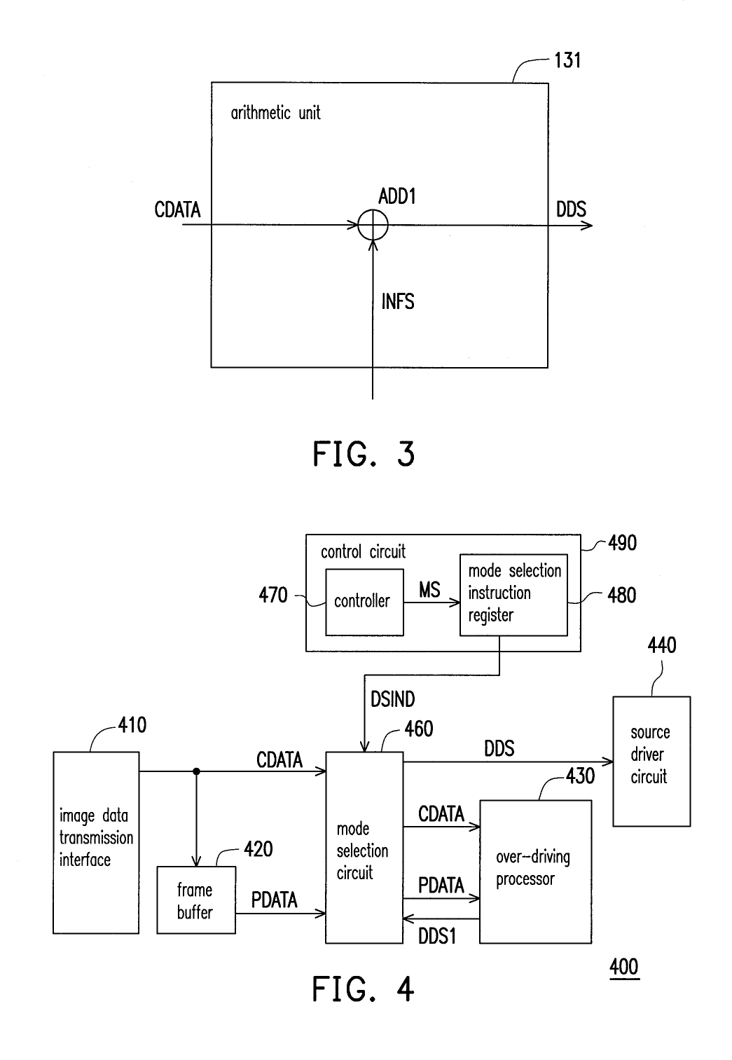

Referring to FIG. 3, FIG. 3 schematically illustrates an arithmetic unit 131 in an embodiment of the present invention. The arithmetic unit 131 includes an adder ADD1. The adder ADD1 is coupled to the lookup table 132 as well as the image data transmission interface 110, and receives the signal adjustment information INFS and the current image data CDATA respectively. The Adder ADD1 adds the signal adjustment information INFS to the current image data CDATA to generate the display driving signal DDS. Hence, when the signal adjusting information INFS is a larger positive value, the arithmetic unit 131 correspondingly generates a larger value of the display driving signal DDS to speed up the response of the corresponding pixel.

Referring to FIG. 4, FIG. 4 is a schematic diagram of a display driving device 400 to an embodiment of the present invention. The display driving device 400 includes an image data transmission interface 410, a frame buffer 420, an over-driving processor 430, a source driver circuit 440, a mode selection circuit 460 and a control circuit 490. In other words, the difference between the display driving device 400 and the display driving device illustrated in FIG. 1 is that the display driving device 400 further comprises the mode selection circuit 460 and the control circuit 490.

The image data transmission interface 410 is coupled to the frame buffer 420 and the mode selection circuit 460, wherein the image data transmission interface 410 can transmit the current image data CDATA to the frame buffer 420 and the mode selection circuit 460. The frame buffer 420 temporarily stores the current image data CDATA and delivers the previous stored image data, i.e., the previous image data PDATA, to the mode selection circuit 460.

The mode selection circuit 460 is further coupled to the over-driving processor 430 and a mode selection instruction register 480. When the display driving device 400 is in the dynamic display mode, the mode selection circuit 460 selects to transmit the current image data CDATA from the image data transmission interface 410 to the over-driving processor 430, and selects to transmit the previous image data PDATA stored in the frame buffer 420 to the over-driving processor 430 in order to generate an output signal DSS1 as the display driving signal DDS which is transmitted to a source driver circuit 440. However, when the display driving device 400 is in the static display mode, the mode selection circuit 460 blocks the route for the current image data CDATA and the previous image data PDATA to be transmitted to the over-driving processor 430, and it directly outputs the previous image data PDATA to the source driver circuit 440 as the display driving signal DDS.

The mode selection circuit 460 receives a mode selection signal DSIND generated by the control circuit 490, wherein the mode selection signal DSIND indicates whether the display driving device 400 is in dynamic display mode or in static display mode. The control circuit 490 includes a controller 470 and a mode selection instruction register 480. The mode selection signal DSIND is generated from a mode selection instruction MS transmitted by the controller 470 and temporarily stored in the mode selection instruction register 480. More specifically, when the display driving device 400 perceives a mode change into the static display mode or the dynamic display mode, the controller 470 will correspondingly generate the mode selection instruction MS and transmit to the mode selection instruction register 480. After receiving the mode selection instruction MS, the mode selection register 480 correspondingly generates the mode selection signal DSIND, and then transmits the mode selection signal DSIND to the mode selection circuit 460 as to indicate whether the display driving device 400 is in the dynamic display mode or in the static display mode.

It should be noted that the display driving device 400 could follow the user's setting or automatically detect the change of the pixels within a sequence of consecutive frames to recognize whether the coming display image is the dynamic image or static image, and determine the display driver device is entering the static display mode or the dynamic display mode. The detection method related to the dynamic display mode or the static display mode is the technique familiar by those ordinarily skilled in the art and thus detail descriptions are not repeated hereinafter.

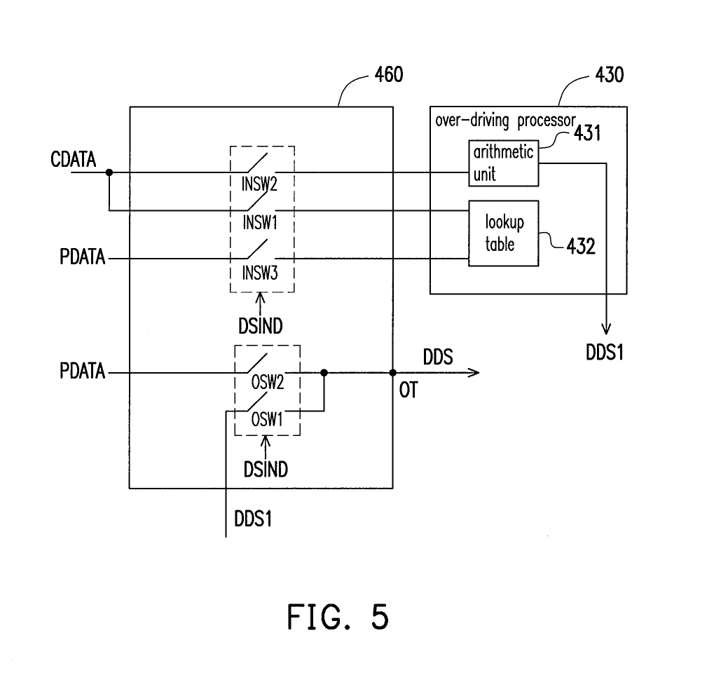

With reference to FIG. 4 and FIG. 5, FIG. 5 is a schematic diagram of a mode selection circuit 460 of an embodiment in FIG. 4. The mode selection circuit 460 includes a first output switch OSW1, a second output switch OSW2 and a first input switch to a third input switch INSW1˜INSW3.

The first output switch OSW1 is disposed between the arithmetic unit 431 of the over-driving processor 430 and an output terminal OT of the display driving signal. The second output switch OSW2 disposed between the frame buffer 410 and the output terminal OT. The conducted or cut off status of the first output switch OSW1 and the second output switch OSW2 is controlled by the mode selection signal DSIND. When the display driving device 400 is in the dynamic display mode, the first output switch OSW1 is conducted and the second output switch OSW2 is cut off; whereas the display driving device 400 is in the static display mode, the first output switch OSW1 is cut off and the second output switch OSW2 is conducted.

Furthermore, the first input switch INSW1 is disposed between the image data transmission interface 410 and the lookup table 432 in order to conduct or block the route for transmitting the current image data CDATA to the lookup table 432. The second input switch INSW2 is disposed between the image data transmission interface 410 and the arithmetic unit 431 in order to conduct or block the route for transmitting the current image data CDATA to the arithmetic unit 431. In addition, the third input switch INSW3 is disposed between the frame buffer 420 and the lookup table 432 in order to conduct or block the route for transmitting the previous image data PDATA to the lookup table 432. The first, second and third input switches INSW1˜INSW3 could be controlled by the mode selection signal DSIND. When the display driving device 400 is in the dynamic display mode, the input switches INSW1˜INSW3 are cut off; whereas the display driving device 400 is in the static display mode, the input switches INSW1˜INSW3 are conducted.

That is, in the present embodiment, when the display driving device 400 is in the static display mode, the mode selection circuit 460 can disconnect all transmitted routes to the over-driving processor 430, and transmit the previous image data PDATA as the display driving signal DDS. On the other hand, when the display driving device 400 is in the dynamic display mode, the mode selection circuit 460 can conduct all transmitted routes to the over-driving processor 430, and choose the output signal DDS1 of the over-driving processor as the display driving signal DDS.

In summary, the above embodiments indicate that the image data from the image data transmission interface are transmitted directly to the over-driving processor and the frame buffer without being stored in any intermediate data register, memory or buffer. Therefore, within only one frame buffer, the over-driving processor can compute the driving voltage needed for generating the display driving signal according to the current image data from the image data transmission interface and the previous image data from the frame buffer. In addition, when displaying the dynamic images, the display driving device is able to effectively realize the over driving technique in order to enhance the display quality, and also avoid the raise of the cost from disposing the extra buffers. As a result, the product is more competitive.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A display driving device, comprising:
an image data transmission interface, for transmitting an image data;
a frame buffer, coupled to the image data transmission interface for storing the image data; and
a over-driving processor, coupled to the image data transmission interface for receiving a current image data transmitted by the image data transmission interface, the over-driving processor coupled to the frame buffer for receiving a previous image data stored by the frame buffer, and the over-driving processor generates a display driving signal according to the current image data and the previous image data in a dynamic display mode.

2. The display driving device according to claim 1, wherein the display driving signal are provided to a plurality of source driver circuits.

3. The display driving device according to claim 1, wherein the over-driving processor comprises:
a lookup table, coupled to the image data transmission interface and the frame buffer, the lookup table is used for looking up a signal adjusting information according to the current image data and the previous image data; and
an arithmetic unit, coupled to the lookup table and the image data transmission interface for executing a computation to the current image data according to the signal adjusting information and generating the display driving signal.

4. The display driving device according to claim 3, wherein the arithmetic unit comprises an adder configured to add the signal adjusting information to the current image data for generating the display driving signal.

5. The display driving device according to claim 1, further comprising:
a mode selection circuit selects either transmitting the image data from the image data transmission interface to the over-driving processor or not, and selects either transmitting the image data from the frame buffer to the over-driving processor or transmitting the image data from the frame buffer to be the display driving signal according to whether the display driving device is in the dynamic display mode or not.

6. The display driving device according to claim 5, wherein when the display driving device is in a static display mode different from the dynamic display mode, the mode selection circuit does not transmit the image data from the image data transmission interface to the over-driving processor, and transmits the image data from the frame buffer to be the display driving signal.

7. The display driving device according to claim 3, further comprising a mode selection circuit, the mode selection circuit comprises:
a first output switch, disposed between the arithmetic unit and an output terminal for outputting the display driving signal, the first output switch is conducted in the dynamic display mode and the first output switch is cut off in the static display mode; and
a second output switch, disposed between the frame buffer and an output terminal, the second output switch is cut off in the dynamic display mode and the second output switch is conducted in the static display mode.

8. The display driving device according to claim 7, wherein the mode selection circuit further comprises:
a first input switch disposed between the image data transmission interface and the lookup table;
a second input switch disposed between the image data transmission interface and the arithmetic unit; and
a third input switch disposed between the frame buffer and the lookup table, wherein the first input switch, the second input switch and the third input switch are conducted in the dynamic display mode and cut off in the static display mode.

9. The display driving device according to claim 4, further comprising:
a control circuit coupled to the mode selection circuit is configured to generate a mode selection signal to indicate the display driving device is in the dynamic display mode or in the static display mode.

10. The display driving device according to claim 9, wherein the control circuit further comprises:
a controller, for generating a mode selection instruction; and
a mode selection instruction register coupled between the controller and the mode selection circuit, and the mode selection instruction register is configured to temporarily store the mode selection instruction and transmit the mode selection signal to the mode selection circuit according to the mode selection instruction.

11. A display apparatus, comprising:
a display panel; and
the display driving device according to claim 1, wherein the display driving device is configured to generate a driving signal to drive the display panel.
